(19) United States
(12) Patent Application Publication
(10) Pub. No.: US 2016/0194145 A1
(43) Pub. Date: Jul. 7, 2016

(54) KNIFE HOLDER

(71) Applicant: Outdoor Edge Cutlery Corporation, Denver, CO (US)

(72) Inventor: David R. Bloch, Morrison, CO (US)

(21) Appl. No.: 14/987,546

(22) Filed: Jan. 4, 2016

Related U.S. Application Data
(60) Provisional application No. 62/099,350, filed on Jan. 2, 2015.

(51) Int. Cl. B65D 85/00; B26B 11/00; A01K 81/04; B65D 25/10; B65D 51/24; B25G 1/04; B26B 3/00

(52) U.S. Cl. CPC B65D 85/70; B25G 1/04; B26B 11/00; B26B 3/00; B65D 25/10; B65D 51/24; A01K 81/04

(57) ABSTRACT

A knife holder is provided that is adapted to selectively receive a knife. The knife holder may include a lock, but the primary fastening mechanism between the knife and the knife holder is a cord. The knife holder may also have a handle with an open end for selective receipt of a branch, pole, or other similar device to convert the knife and knife holder into a harpoon.

This application claims the benefit of U.S. Provisional Patent Application Ser. No. 62/099,350, filed Jan. 2, 2015, the entirety of which is incorporated by reference herein.

### FIELD OF THE INVENTION

Embodiments of the present invention are generally related to a holder used to secure a knife. Some knife holders described herein can also receive a shaft to form a harpoon used by hunters and survivalists.

### BACKGROUND OF THE INVENTION

FIGS. 1 and 2 show a knife 2 used by hunters and survivalists formed from a single piece of metal that includes a blade 6 at one end with a sharpened tip/point and a pommel 10 at an opposite end. The blade 6 has an edge 12 that may be straight, serrated, or combination thereof. The blade 6 ends at a heal 9 is adjacent to a finger guard 14. The finger guard leads to a tang 18 that connects the blade 6 to the pommel 10. The pommel 10 may have a shaped profile that terminates at a point 22 (e.g., a hawk's bill point). The tang 18 and pommel 10 may include a plurality of holes 26, which, as shown in FIG. 2, are used to receive a cord 30 or rope that is also wound around the tang. Knots 34 in the cord 30 located near the blade 6 and the pommel 10 maintain the cord 30 around the tang. The cord 30 increases tang 18 width to create a selectively modifiable grip. The knife 2 shown in FIG. 1 can be used with or without the cord 30.

Survivalists or hunters can use the sharp point 22 or edge of the pommel 10 to cut a groove into a pole, shaft, or branch. A harpoon is created by placing a portion of the tang into the groove, wherein the cord is used to fasten the knife to the shaft. In this configuration, the knife is a tip of a harpoon that can be used for fishing, hunting, or self defense.

Although the knife 2 is useful in many situations, one of ordinary skill in the art will appreciate that sometimes the spear or harpoon would be more useful. Accordingly, embodiments of the present invention enable individuals to quickly transform a knife to a harpoon.

### SUMMARY OF THE INVENTION

It is one aspect of embodiments of the present invention to provide a device that allows a knife to be converted into a harpoon for hunting and fishing. More specifically, a knife holder is provided that receives a knife. The contemplated knife holder has a groove, slot, or pocket that receives portions of the knife tang and pommel. The knife holder may have an elongated handle so the user can grip the knife away from the blade, which enhances safety. The knife holder groove dimensions may closely match the knife outer dimensions to provide a firm and stable interface between the knife and the knife holder. To further enhance the interface between the knife and the knife holder, some embodiments of the present invention have a lock that selectively engages one of the knife holes, which may have been previously used to receive a cord. The lock may be a spring-loaded detent or other type of lock used in a knife industry. Some embodiments employ a screw, bolt, pin, or similar member placed through the handle and the knife to secure the knife to the knife holder. In some embodiments, the lock is used to temporarily retain the knife within the knife holder, and a secondary device is used to firmly secure the knife to the knife holder. For example, the knife holder may possess a plurality of holes that correspond with the knife holes, and the cord is used to secure the knife to the knife holder.

The handle may have a hollow portion accessible through a selectively interconnected end piece. The end piece may be threateningly engaged to the handle. In other embodiments, the end piece is a snap fit onto the handle. The end piece may have an integrated compass or Ferrocerium fire starter rod. The hollow portion is ideal for storing first aid and survival equipment, such as matches, a lighter, fishing gear, communications equipment, etc. In addition, the handle may accommodate or incorporate a flashlight, wherein the hollow portion is used to store or accommodate batteries. The handle may have threads for selective interconnection to a pole shaft, or a standard threaded broom handle or painting pole extension, which may be foldable, jointed, telescoping, or otherwise easily reduced in size for storage.

For some embodiments of the present invention, a knife holder is not required. More specifically, the knife may include a hawk's bill point at its pommel end. The point is used to create a groove or a channel in a green shaft (i.e., a branch) that receives the knife tang. A knife is then tied to the shaft with the cord to create a harpoon.

In one embodiment of the present invention, the knife is about 8.25 inches (21 cm) long, wherein the blade is about 2.9 inches (7.4 cm) long. The blade may be made of stainless steel (7cr17) with a Rockwell C hardness of about 56. The knife holder may be made of Zytel® glass-nylon, wherein the system weighs about 8.9 ounces (250 g).

It is another aspect of embodiments of the present invention to provide a knife holder adapted for selective receipt of a knife that is comprised of a blade spaced from a hooked pommel by a tang, the handle comprising: a knife securing portion with a pocket adapted to receive the knife pommel and handle; a first hole extending through the knife securing portion; a second hole extending through the knife securing portion; a lock incorporated into the knife securing portion, the lock having a selectively movable detent positioned in the pocket; a handle interconnected with the knife securing portion; and wherein when the knife is positioned in the pocket, the first hole is aligned with a first hole of the knife, and the second hole selectively receives the detent.

It is another aspect of embodiments of the present invention to provide a harpoon, comprising: a knife comprising: a blade, a tang interconnected to the blade, a pommel interconnected to the tang, and wherein the tang includes a first aperture and the pommel includes a second aperture; a knife holder having a pocket for selective receipt of the knife pommel and handle, the knife holder having a lock comprising a selectively movable detent positioned in the pocket; a handle interconnected with the knife holder; and a shaft interconnected to the handle.

It is still yet another aspect of embodiments of the present invention to provide a method of forming a harpoon, comprising: providing a knife comprising of a blade, a tang interconnected to the blade, a pommel interconnected to the tang, and wherein the tang includes a first aperture and the pommel includes a second aperture; providing a knife holder having a pocket for selective receipt of the knife pommel and handle, the knife holder having a lock comprising a selectively movable detent positioned in the pocket; providing a handle interconnected to the knife holder; inserting the knife into the pocket; aligning the first aperture of the knife with a corresponding first aperture of the knife holder; aligning the second aperture of the knife with the detent so that the knife is fixed to the knife holder; and interconnecting a shaft to the handle.

The Summary of the Invention is neither intended nor should it be construed as being representative of the full extent and scope of the present invention. That is, these and other aspects and advantages will be apparent from the disclosure of the invention(s) described herein. Further, the above-described embodiments, aspects, objectives, and configurations are neither complete nor exhaustive. As will be appreciated, other embodiments of the invention are possible using, alone or in combination, one or more of the features set forth above or described below. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description of the Invention and no limitation as to the scope of the present invention is intended by either the inclusion or non-inclusion of elements, components, etc. in this Summary of the Invention. Additional aspects of the present invention will become more readily apparent from the Detail Description, particularly when taken together with the drawings.

### BRIEF DESCRIPTION OF THE DRAWINGS

The accompanying drawings, which are incorporated in and constitute a part of the specification, illustrate embodiments of the invention and with the general description of the invention given above and the detailed description of the drawings given below, explain the principles of these inventions.

FIG. 1 is an elevation view of a knife used with one embodiment of the present invention;

FIG. 2 is the knife of FIG. 1, wherein a portion of the knife is wrapped with a cord to form a grip;

FIG. 3 is a detailed view of a knife holder;

FIG. 4 is a side view of the knife holder;

FIG. 5 is a partial view showing the knife holder securing the knife;

FIG. 6 shows the knife holder of FIG. 5, wherein the utility knife is secured to the knife holder with a cord;

FIG. 7 shows the knife of one embodiment having a point and adapted for forming a groove in a shaft;

FIG. 8 shows the knife of FIG. 7 secured to the shaft with a cord;

FIG. 9 shows a hunter using a harpoon of one embodiment of the present invention; and

FIG. 10 shows the handle end of one embodiment of the present invention.

To assist in the understanding of one embodiment of the present invention the following list of components and associated numbering found in the drawings is provided herein:

| # | Component |
|---|---|
| 2 | Knife |
| 6 | Blade |
| 8 | Tip |
| 9 | Heal |
| 10 | Pommel |
| 14 | Finger guard |
| 18 | Tang |
| 22 | Point |
| 26 | Hole |
| 30 | Cord |
| 34 | Knot |
| 38 | Knife holder |
| 42 | Groove |
| 46 | Hole |
| 50 | Lock |
| 52 | Detent |
| 54 | Handle |
| 58 | Hollow portion |
| 62 | Harpoon |
| 66 | Channel |
| 70 | Shaft |
| 76 | Hunter |
| 78 | Pole |
| 82 | Matches |
| 86 | Fishhooks |
| 90 | Fishing line |
| 94 | Cap |
| 98 | Compass |

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

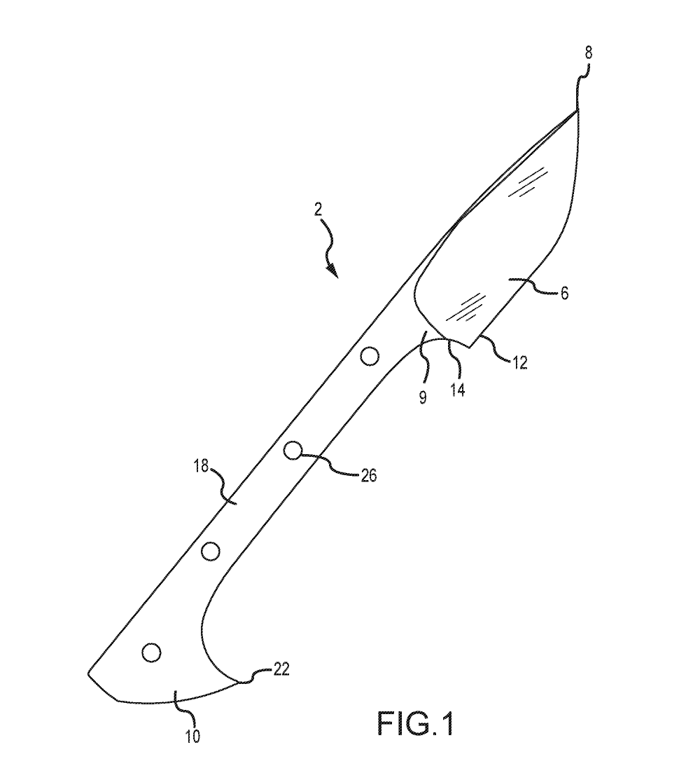

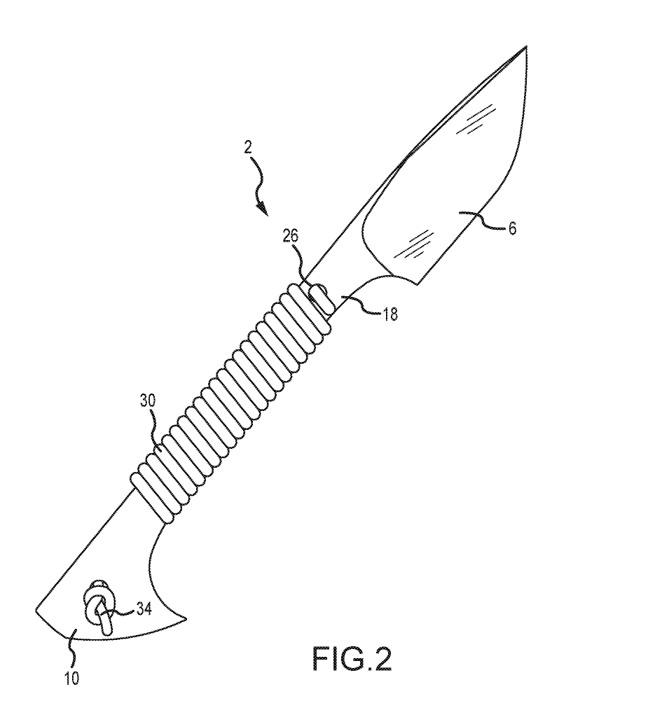

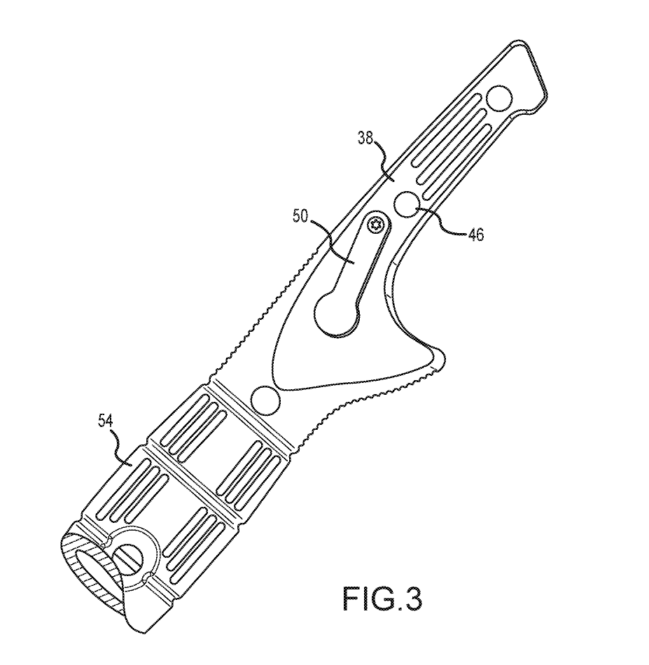

FIGS. 3-6 show a knife holder 38 for selectively receiving a knife 2 of one embodiment of the present invention. The knife holder 38 is designed to selectively interface with a tang and pommel of a knife (see FIGS. 1 and 2). The holder includes a groove 42 or slot for receipt of the knife 2. In one embodiment of the present invention, the dimensions of the groove 42 closely match corresponding portions of the knife 2. The knife holder 38 may include a plurality of holes 46 that correspond to holes 26 in the knife.

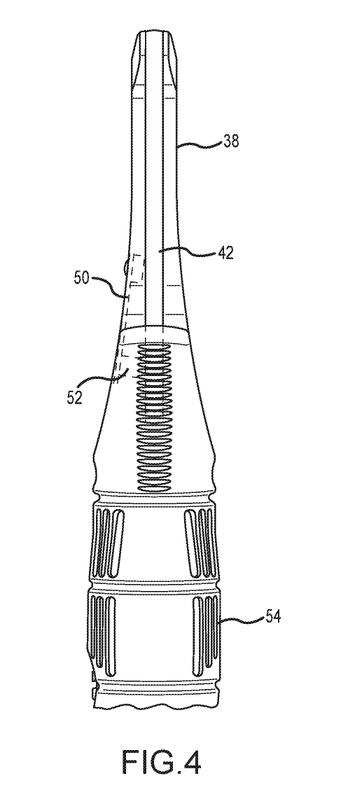

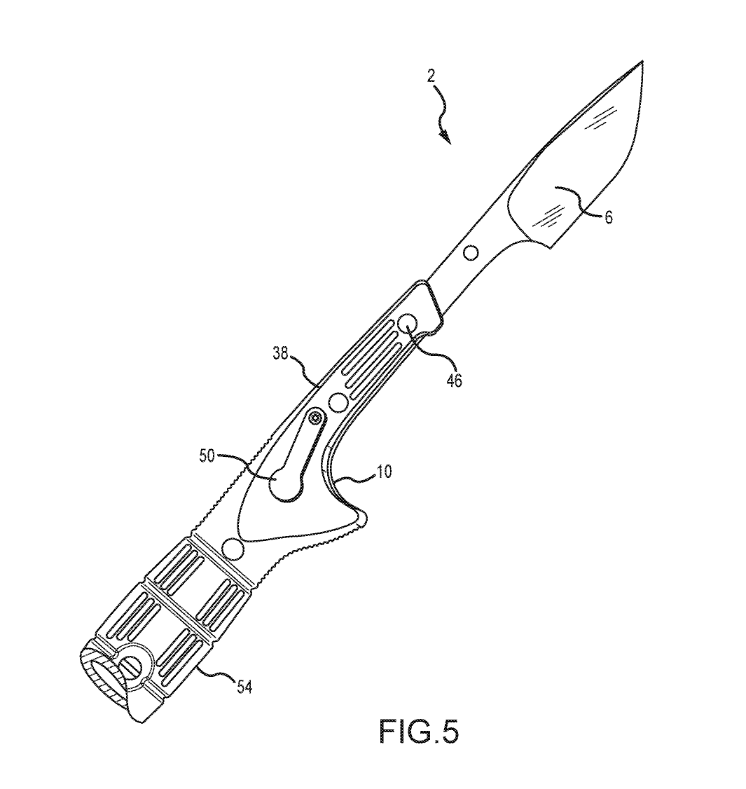

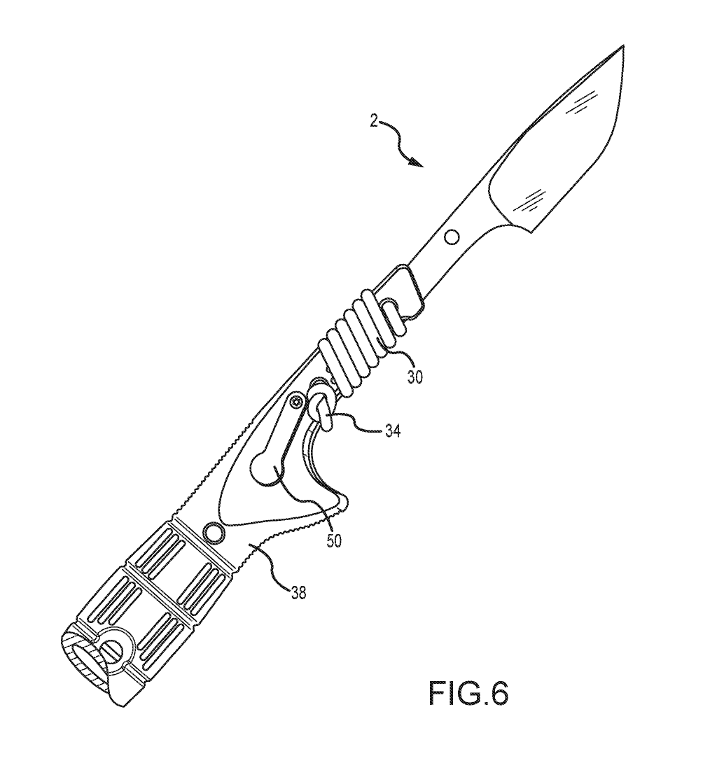

FIGS. 3 and 4 show the knife holder 38 of one embodiment of the present invention that includes the groove 42 that selectively receives a blade shown in FIG. 1. When the knife is installed, the holes 26 thereof are aligned with the holes 46 of the knife holder 38 as shown in FIG. 5. FIG. 6 shows the aligned holes that accept a cord 30 to fasten the knife 2 to the knife holder 38. Some embodiments of the present invention also include a lock 50 that selectively interfaces with a knife hole 26 positioned in the pommel 10. Here, the lock 50 comprises a leaf spring mechanism wherein an end is operatively interconnected to an outer or inner surface of the knife holder 38, and an end with a detent 52 that selectively interfaces with the knife hole. The knife holder 38 also includes a handle 54 used to extend the length of the knife. The handle 54 may have a hollow portion 58 for holding items and for receiving a shaft.

FIG. 6 shows the knife 2 secured to the knife holder 38 by using the cord 30 that was previously wrapped about the tang to define the knife handle. Similar to the example shown in FIGS. 1 and 2, a portion of cord is threaded through the knife and knife holder and wrapped around knife holder, which secures the knife 2 to the holder 38. Again, the lock 50 may be provided that aids in the interconnection between the knife and the knife holder. In addition, the lock 50 allows the knife 2 to be interconnected to the knife holder 38 while the cord 30 is wrapped.

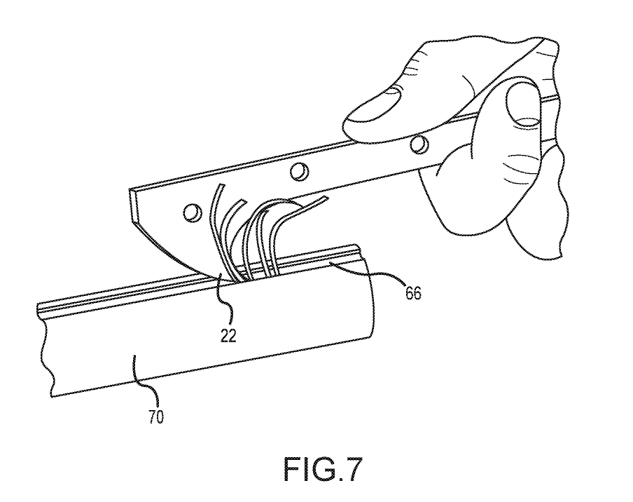

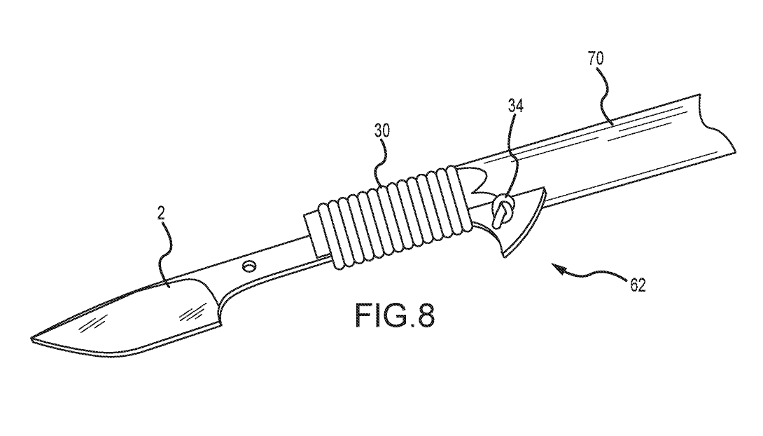

FIGS. 7 and 8 show another way a knife 2 can be made into a harpoon 62. Here, the knife 2 is used to cut a channel 66 into a green shaft 70, which can be a branch. The knife 2 is then placed within the channel 66 and the cord 30 is used to secure the knife 2 to the shaft 70.

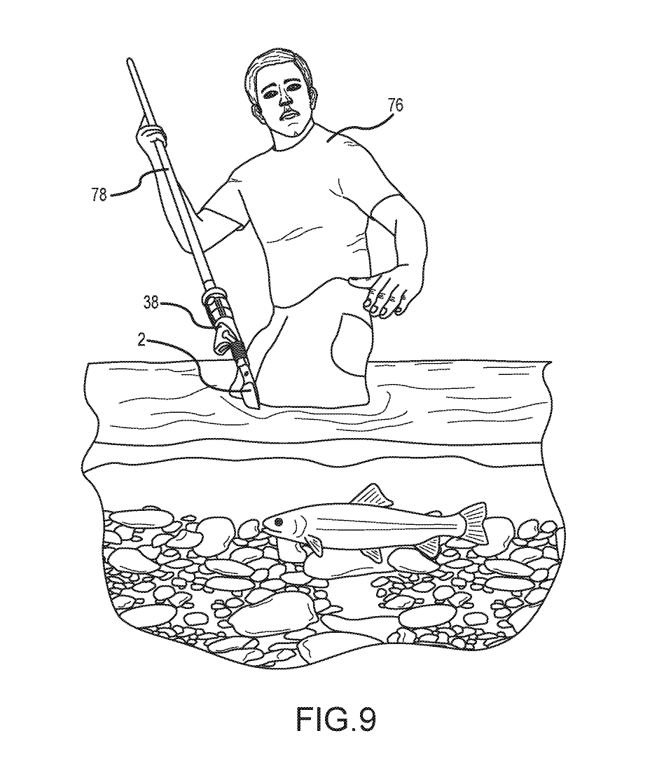

FIG. 9 shows a hunter 76 using the contemplated system. Here, the knife 2 is firmly attached to the knife holder 38 interconnected to a pole 78. The knife holder 38 may possess threads for receiving the pole 78. Further, the knife holder 38 may include a set screw that helps firmly secure the pole 78. The hunter 76 uses the harpoon 62 to hunt wild game, birds, or fish.

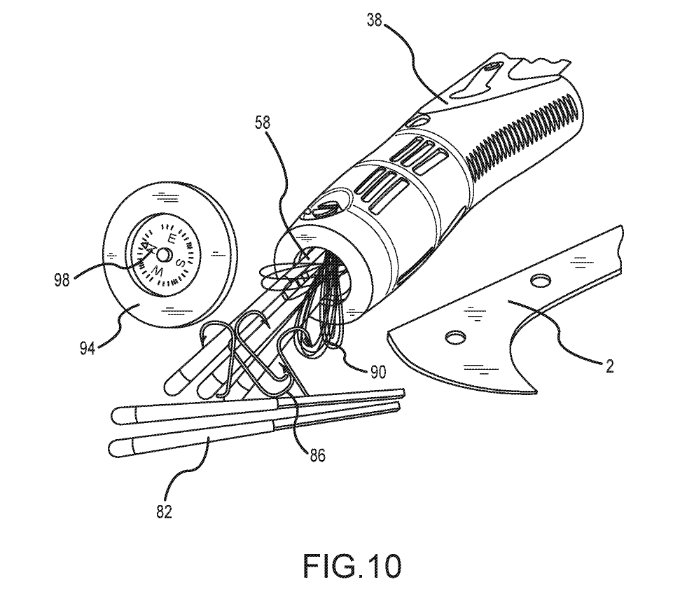

As shown in FIG. 10, the knife holder 38 of one embodiment of the present invention includes a hollow portion 58 for the storage of matches 82, fishhooks 86, fishing line 90, and other survival gear. The hollow portion 58 may have threads for selectively securing a pole, which may possess corresponding threads, such as on a replacement broom handle or painting pole extension. The hollow portion 58 is closed with a cap 94, which may include a compass 98 or ferrocerium fire starter rod. In one embodiment the cap 94 includes a threaded portion that selectively interfaces with threads associated with the hollow portion 58. In this embodiment, the fire starter rod extends from the threaded portion of the cap such that the fire starter rod is positioned within the hollow portion 58 when not in use. Those of ordinary skill the art will appreciate that the length of the handle may be increased so more items may be stored.

While various embodiments of the present invention have been described in detail, it is apparent that modifications and alterations of those embodiments will occur to those skilled in the art. It is to be expressly understood that such modifications and alterations are within the scope and spirit of the present invention, as set forth in the following claims. Further, it is to be understood that the invention(s) described herein is not limited in its application to the details of construction and the arrangement of components set forth in the preceding description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

What is claimed is:

1. A knife holder adapted for selective receipt of a knife that is comprised of a blade with a sharp point spaced from a hooked pommel by a tang, said handle comprising:
a knife securing portion with a pocket adapted to receive the knife pommel and handle;
a first hole extending through said knife securing portion;
a second hole extending through said knife securing portion;
a lock incorporated into said knife securing portion, said lock having a selectively movable detent positioned in said pocket;
a handle interconnected with said knife securing portion; and
wherein when the knife is positioned in said pocket, said first hole is aligned with a first hole of the knife, and said second hole selectively receives said detent.

2. The knife holder of claim 1, wherein said knife securing portion has a hooked portion that is also associated with said pocket, said hooked portion adapted to receive a hooked pommel.

3. The knife holder of claim 1, wherein said handle is at least partially hollow, wherein said hollow portion of said handle is accessible through a cap selectively interconnected to said handle.

4. The knife holder of claim 1, wherein said cap includes a compass or a ferrocerium fire starter rod.

5. The knife holder of claim 1, further comprising a cord threaded through said first hole, said cord interconnecting said knife to said knife holder.

6. The knife holder of claim 1, wherein said handle has an open end with a threaded portion that is adapted to receive a staff.

7. A harpoon, comprising:
a knife comprising:
a blade,
a tang interconnected to said blade,
a pommel interconnected to said tang, and
wherein said tang includes a first aperture and said pommel includes a second aperture;
a knife holder having a pocket for selective receipt of the knife pommel and handle, said knife holder having a lock comprising a selectively movable detent positioned in said pocket;
a handle interconnected with said knife holder; and
a shaft interconnected to said handle.

8. The knife holder of claim 7, wherein said knife holder has a hooked portion that is also associated with said pocket, said hooked portion adapted to receive a hooked pommel.

9. The knife holder of claim 8, wherein said hooked pommel has a pointed end.

10. The knife holder of claim 7, wherein said handle is at least partially hollow, wherein said hollow portion of said handle is accessible through a cap selectively interconnected to said handle.

11. The knife holder of claim 10, wherein said shaft fits within said hollow portion.

12. The knife holder of claim 10, wherein said cap includes a compass or a ferrocerium fire starter rod.

13. The knife holder of claim 7, further comprising a cord threaded through said first hole, said cord interconnecting said knife to said knife holder.

14. The knife holder of claim 10, wherein said handle has an open end with a threaded portion that is adapted to receive said staff.

15. A method of forming a harpoon, comprising:
providing a knife comprising of a blade, a tang interconnected to said blade, a pommel interconnected to said tang, and wherein said tang includes a first aperture and said pommel includes a second aperture;
providing a knife holder having a pocket for selective receipt of the knife pommel and handle, said knife holder having a lock comprising a selectively movable detent positioned in said pocket;
providing a handle interconnected to said knife holder;
inserting said knife into said pocket;
aligning said first aperture of said knife with a corresponding first aperture of said knife holder;
aligning said second aperture of said knife with said detent so that said knife is fixed to said knife holder; and
interconnecting a shaft to said handle.

16. The knife holder of claim 15, wherein said knife holder has a hooked portion that is also associated with said pocket, said hooked portion adapted to receive a hooked pommel.

17. The knife holder of claim 16, wherein said hooked pommel has a pointed end.

18. The knife holder of claim 15, wherein said handle is at least partially hollow, wherein said hollow portion of said handle is accessible through a cap selectively interconnected to said handle.

19. The knife holder of claim 18, wherein said shaft fits within said hollow portion.

20. The knife holder of claim 15, further comprising threading a cord through said first hole to interconnect said knife to said knife holder.

21. The knife holder of claim 18, wherein said shaft is threadingly interconnected to said handle.
